(19) United States
(12) Patent Application Publication
(10) Pub. No.: US 2026/0302549 A1
(43) Pub. Date: Oct. 1, 2026

(54) ELECTRODE, ELECTRODE PRODUCTION METHOD, AND ALL-SOLID-STATE BATTERY

(71) Applicant: HONDA MOTOR CO., LTD., Tokyo (JP)

(72) Inventors: Kenichiro NAKAGOME, Saitama (JP); Daisuke KANEKO, Saitama (JP); Norihiro YOSHIDA, Saitama (JP)

(21) Appl. No.: 19/570,172

(22) Filed: Mar. 18, 2026

(30) Foreign Application Priority Data
Mar. 25, 2025 (JP) 2025-049846

(51) Int. Cl. H01M 50/533; H01M 4/04; H01M 10/0562; H01M 10/0585; H01M 50/586

(52) U.S. Cl. CPC H01M 50/533; H01M 4/0435; H01M 10/0562; H01M 10/0585; H01M 50/586

(57) ABSTRACT

A positive electrode 20 is an electrode including positive-electrode active material layers 25 and a positive-electrode current collector layer 21. The positive-electrode current collector layer 21 includes a positive-electrode electrode portion 22 adapted to have the positive-electrode active material layers 25 arranged thereon, and a positive-electrode extension portion 23 extending from one end of the positive-electrode electrode portion 22. The positive-electrode extension portion 23 includes a positive-electrode tab region 231 having a width narrower than that of the positive-electrode electrode portion 22, and a positive-electrode inclined region 232 that is a region between the positive-electrode electrode portion 22 and the positive-electrode tab region 231, and is inclined so that a width thereof narrows as it approaches the positive-electrode tab region 231 from the positive-electrode electrode portion 22 side. The inclination angle θ of the positive-electrode inclined region 232 with respect to the positive-electrode electrode portion 22 is 120° to 130°.

This application is based on and claims the benefit of priority from Japanese Patent Application No. 2025-049846, filed on 25 Mar. 2025, the content of which is incorporated herein by reference.

### BACKGROUND OF THE INVENTION

### Field of the Invention

The present invention relates to an electrode, an electrode production method, and an all-solid-state battery.

### Related Art

In recent years, research and development on secondary batteries that contribute to improved energy efficiency has been carried out to provide more people with affordable, reliable, sustainable, and advanced energy.

Among secondary batteries, all-solid-state batteries, which use a solid electrolyte as the electrolyte, are attracting particular attention because of advantages such as high safety, stemming from the non-flammability of the solid electrolyte, and higher energy density. As the all-solid-state batteries, those having a stacked structure are being considered, in which a plurality of electrodes (i.e., positive electrodes and negative electrodes) are alternately stacked with solid electrolyte layers interposed therebetween. As a method for drawing positive electrodes and negative electrodes of an all-solid-state battery with a stacked structure to the outside of the battery, a method is considered that includes providing each of positive-electrode current collectors and negative-electrode current collectors with an extension portion formed to extend in a tapered shape, and connecting the tip of the extension portion to a lead tab (for example, Japanese Unexamined Patent Application, Publication No. 2023-152733).
Patent Document 1: Japanese Unexamined Patent Application, Publication No. 2023-152733

### SUMMARY OF THE INVENTION

By the way, an electrode is formed by stacking a current collector and an electrode active material layer. The density of the stacked structure of the current collector and the electrode active material layer is increased by pressing. However, each of the current collector and the electrode active material layer is rolled during pressing. The electrode active material layer is likely to elongate to a greater degree than the current collector. A part of the current collector on which the electrode active material layer is stacked tends to elongate so as to follow the electrode active material layer. Therefore, during pressing, strain may occur in the current collector around the boundary between the part of the current collector on which the electrode active material layer is stacked and the extension portion, which in turn may cause cracking of the current collector. In particular, regarding an all-solid-state battery with a stacked structure, an extension portion needs to be formed long to such an extent that each of a plurality of positive-electrode current collectors and negative-electrode current collectors can be bundled into a single group within the all-solid-state battery and then drawn to the outside of the battery. However, increasing the length of the extension portion makes it more prone to cracking.

An object of the present invention is to provide an electrode, an electrode production method, and an all-solid-state battery, each capable of increasing the density of an electrode, and reducing the risk of damage to the electrode.
(1) The present invention relates to an electrode including an electrode active material layer and a current collector layer, the current collector layer including an electrode portion adapted to have the electrode active material layer arranged on the electrode portion, and an extension portion extending from one end of the electrode portion, the extension portion including a tab region having a width narrower than that of the electrode portion, and an inclined region that is a region between the electrode portion and the tab region, and is inclined so that a width thereof narrows as the inclined region approaches the tab region from the electrode portion side, and an inclination angle of the inclined region with respect to the electrode portion being 120° to 130°.

According to the electrode described in (1), pressing the electrode can increase its density.

Meanwhile, during pressing, stress is likely to occur in a region around the proximal end portion of the extension portion due to the difference in ductility between the current collector layer and the electrode active material layer. Stress concentration is likely to occur in a region around the proximal end portion of the tab region as an edge of the tab region is angular. However, by providing the inclined region, it is possible to allow the proximal end portion of the tab region to be positioned away from the proximal end portion of the extension portion. In addition, by increasing the inclination angle of the inclined region with respect to the electrode portion, it is possible to allow the proximal end portion of the tab region to be more easily positioned away from the proximal end portion of the extended region. This can more easily reduce stress generated at the proximal end portion of the tab region.

During pressing, stress is likely to occur in a region around an end portion of the proximal end portion of the extension portion in a direction perpendicular to the extension direction of the extension portion (simply referred to as the “extension direction”). However, by providing the inclined region, it is possible to reduce the volume of the current collector arranged in the region around the end portion of the proximal end portion of the extension portion in a direction (referred to as the “width direction”) perpendicular to the extension direction. By reducing the inclination angle of the inclined region with respect to the electrode portion, it is possible to more easily reduce the volume of the current collector arranged in the region around the end portion in the width direction of the proximal end portion of the extension portion. This can more easily reduce stress generated at the proximal end portion of the extension portion.

By setting the inclination angle of the inclined region with respect to the electrode portion to 120° to 130°, it is possible to reduce stress concentration at the proximal end portion of the tab region and stress concentration in the region around the end portion in the width direction of the proximal end portion of the extension portion in a well-balanced manner.

Thus, an all-solid-state battery can be provided that can have an electrode with high density and have a low risk of damage to the electrode.
(2) In the electrode described in (1) above, the inclined region may be inclined in a straight line.

According to the electrode described in (2), it is possible to reduce the likelihood of the formation of recesses at an edge of the inclined region, thereby reducing stress concentration in the inclined region.
(3) In the electrode described in (1) or (2) above, the electrode active material layer may be arranged at a distance from an end portion of the electrode portion, and a width of an end portion of the inclined region on a side of the electrode portion may be greater than a width of the electrode active material layer.

According to the electrode described in (3), stress is likely to occur in a part of the extension portion aligned with the electrode active material layer in the extension direction due to the elongation of the electrode active material layer. Such stress is also transmitted to a portion around the part of the extension portion aligned with the electrode active material layer in the extension direction.

According to such a configuration, not only an edge of the part of the extension portion aligned with the electrode active material layer in the extension direction, but also an edge of the portion around the part of the extension portion aligned with the electrode active material layer in the extension direction can be formed in an inclined manner. Accordingly, stress concentration can be more suitably reduced.
(4) In the electrode described in any one of (1) to (3) above, the electrode active material layer may be arranged at a distance from an end portion of the electrode portion, and an insulating member may be arranged between the end portion of the electrode portion and the electrode active material layer, and a width of an end portion of the inclined region on a side of the electrode portion may be narrower than a width of the insulating member.

According to the electrode described in (4), the solid electrolyte layer is formed of a relatively hard material. Therefore, by stacking the solid electrolyte layer on the electrode and pressing them together, it is possible to allow higher pressure to be applied to the electrode, and thus suitably increase the density of the electrode.

Note that it is considered that strain is likely to occur at the boundary between a part of the current collector layer that overlaps the solid electrolyte layer and a part of the current collector layer that does not overlap the solid electrolyte layer. Therefore, stress is likely to occur in a region where a position in the width direction of the extension portion is aligned with a part of the current collector layer that overlaps an end portion in the width direction of the electrode active material layer. However, by positioning an end portion in the width direction of the inclined region to be closer to one side of the width direction than is an end portion in the width direction of the solid electrolyte layer, it is possible to allow an edge of the part, in which stress is likely to occur, of the extension portion to be formed in an inclined manner. Accordingly, stress concentration can be reduced.

In addition, by positioning one end portion in the width direction of the insulating member to be closer to one side of the width direction than is one end portion in the width direction of the inclined region, it is possible to reduce the contact between the current collector layer and other components in the configuration where the current collector layer (i.e., the inclined region) extends relatively far toward one side of the width direction.
(5) In the electrode described in any one of (1) to (4) above, a ratio of a length of the inclined region in an extension direction of the extension portion to a length of the inclined region in a width direction perpendicular to the extension direction may be 0.25 to 0.45.

According to the electrode described in (5), by increasing the ratio of the length in the extension direction of the inclined region to the length in the width direction of the inclined region, it is possible to allow the proximal end portion of the tab region to be more easily positioned away from the proximal end portion of the extension portion. By reducing the ratio of the length in the extension direction of the inclined region to the length in the width direction of the inclined region, it is possible to more easily reduce the volume of the current collector arranged in the region around the end portion in the width direction of the proximal end portion of the extension portion. Such a configuration can reduce stress concentration at the proximal end portion of the tab region and stress concentration in the region around the end portion in the width direction of the proximal end portion of the extension portion in a well-balanced manner.
(6) The present invention relates to an electrode production method including an electrode preparation step of preparing an electrode that includes an electrode active material layer and a current collector layer, the current collector layer including an electrode portion adapted to have the electrode active material layers arranged on the electrode portion, and an extension portion extending from one end of the electrode portion, the extension portion including a tab region having a width narrower than that of the electrode portion, and an inclined region that is a region between the electrode portion and the tab region, and is inclined so that a width thereof narrows as the inclined region approaches the tab region from the electrode portion side, an inclination angle of the inclined region with respect to the electrode portion being 120° to 130°; and a pressing step of roll-pressing the electrode in a direction perpendicular to an extension direction of the extension portion.

According to the electrode production method described in (6), the density of the electrode can be increased with a simple method.

If the current collector layer is pressed with an apparatus for performing roll press (referred to as a “roll press apparatus”) while being moved in the width direction relative to the roll press apparatus, a difference between the elongation in the width direction of the electrode portion and the elongation in the width direction of the extension portion is particularly likely to occur, which in turn increases the likelihood of fracture of the current collector layer. However, the likelihood of fracture of the current collector layer can be reduced according to the electrode of the present invention. Thus, the foregoing production method can be suitably applied.
(7) The present invention relates to an all-solid-state battery including a positive electrode, a negative electrode, and a solid electrolyte layer arranged between the positive electrode and the negative electrode, one or both of the positive electrode and the negative electrode being the electrode described in (1) or (2).

According to the all-solid-state battery described in (7), an all-solid-state battery can be provided that can have an electrode with high density and have a low risk of damage to the electrode.
(8) In the all-solid-state battery described in (7) above, a width of the solid electrolyte layer may be greater than a width of the electrode active material layer.

According to the all-solid-state battery described in (8), as described above, if the electrode active material layer has a part overlapping the solid electrolyte layer and a part not overlapping the solid electrolyte layer, pressure applied to the part of the electrode active material layer that overlaps the solid electrolyte layer during pressing becomes higher than pressure applied to the part of the electrode active material layer that does not overlap the solid electrolyte layer. Therefore, during pressing, it is considered that a difference in elongation occurs between the part of the electrode active material layer that overlaps the solid electrolyte layer and the part of the electrode active material layer that does not overlap the solid electrolyte layer. Thus, it is considered that strain is likely to occur at the boundary between a part of the current collector layer that overlaps the electrode active material layer and also overlaps the solid electrolyte layer, and a part of the current collector layer that overlaps the electrode active material layer but does not overlap the solid electrolyte layer.

However, according to the foregoing configuration, it is possible to more easily achieve uniform elongation of the electrode active material layer during pressing, thereby reducing the occurrence of strain in the electrode active material layer. Accordingly, stress generated in the electrode active material layer can be reduced.
(9) In the all-solid-state battery described in (7) or (8) above, a width of an end portion of the inclined region on a side of the electrode portion may be greater than a width of the solid electrolyte layer.

According to the all-solid-state battery described in (9), by positioning an end portion in the width direction of the inclined region to be closer to one side of the width direction than is an end portion in the width direction of the solid electrolyte layer, it is possible to allow an edge of the part, in which stress is likely to occur, of the extension portion to be more reliably formed in an inclined manner. Accordingly, stress concentration can be reduced.

According to the present invention, it is possible to provide an electrode, an electrode production method, and an all-solid-state battery, each capable of increasing the density of an electrode, and reducing the risk of damage to the electrode.

### BRIEF DESCRIPTION OF THE DRAWINGS

FIG. 1 is an external perspective view of an all-solid-state battery according to an embodiment;

FIG. 2 is a cross-sectional view of the all-solid-state battery along line II-II in FIG. 1;

FIG. 3 is a plan view of a positive-electrode current collector layer as seen in the stacked direction;

FIG. 4 is an enlarged view of a portion V in FIG. 3;

FIG. 5 is a conceptual view illustrating a method for producing the all-solid-state battery according to an embodiment;

FIG. 6A is a view illustrating the results of CAE analysis for a positive-electrode current collector of No. 1;

FIG. 6B is a view illustrating the results of CAE analysis for a positive-electrode current collector of No. 2;

FIG. 6C is a view illustrating the results of CAE analysis for a positive-electrode current collector of No. 3;

FIG. 6D is a view illustrating the results of CAE analysis for a positive-electrode current collector of No. 4;

FIG. 6E is a view illustrating the results of CAE analysis for a positive-electrode current collector of No. 5;

FIG. 6F is a view illustrating the results of CAE analysis for a positive-electrode current collector of No. 6;

FIG. 6G is a view illustrating the results of CAE analysis for a positive-electrode current collector of No. 7;

FIG. 6H is a view illustrating the results of CAE analysis for a positive-electrode current collector of No. 8;

FIG. 6I is a view illustrating the results of CAE analysis for a positive-electrode current collector of No. 9; and

FIG. 7 is a graph illustrating the maximum stress applied during a press test for each of an example and a comparative example.

### DETAILED DESCRIPTION OF THE INVENTION

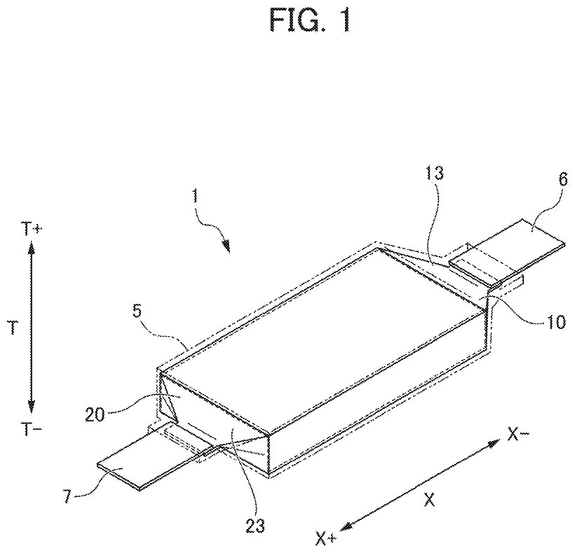

An all-solid-state battery 1 according to an embodiment of the present invention will be described hereinafter. The type of the all-solid-state battery 1 is not limited to a particular type. For example, the all-solid-state battery 1 is an all-solid-state lithium battery that uses lithium ions as a charge transfer medium. As illustrated in FIGS. 1 to 3, the all-solid-state battery 1 has a structure in which a positive electrode 20 and a negative electrode 10 are stacked with a solid electrolyte layer 30 interposed therebetween. Each of the positive electrode 20 and the negative electrode 10 corresponds to an electrode.

In this specification, a direction in which the positive electrode 20 and the negative electrode 10 are stacked shall be referred to as the “T−direction”. The T−direction may also be referred to as a first direction. Among directions perpendicular to the T−direction, the extension direction of an extension portion described below shall be referred to as the “X−direction”. The X−direction may also be referred to as a second direction. A direction perpendicular to both the T−direction and the X−direction shall be referred to as the “Y− direction”. The Y−direction may also be referred to as a third direction. The Y−direction is also a width direction (described later) perpendicular to the extension direction. One direction of the T−direction is designated as the “T+ direction”, and the opposite side of the T+ direction is designated as the “T− direction”, for example. One direction of the X−direction is designated as the “X+ direction”, and the opposite side of the X+ direction is designated as the “X− direction”, for example. One direction of the Y−direction is designated as the “Y+ direction”, and the opposite side of the Y+ direction is designated as the “Y− direction”, for example.

Note that the drawings may be schematically simplified for purposes of illustrating the invention, and the dimensional ratios of the depicted components or between the components may not match those described in the specification. In addition, components described in the specification may be omitted in the drawings, or the drawings may illustrate a reduced number of components, for example. Note that the terms used in the present invention to specify shapes, geometric conditions, and their degrees, such as a “straight line”, “parallel”, “perpendicular”, and “identical (the same)”, as well as the length or angle values, for example, shall be interpreted to include a range that can be expected to provide a similar function, without being strictly limited to their literal meanings.

### (All-Solid-State Battery)

The all-solid-state battery 1 includes a plurality of negative electrodes 10, a plurality of solid electrolyte layers 30, and a plurality of positive electrodes 20, for example. A negative electrode 10, a solid electrolyte layer 30, a positive electrode 20, and another solid electrolyte layer 30 are stacked in this order.

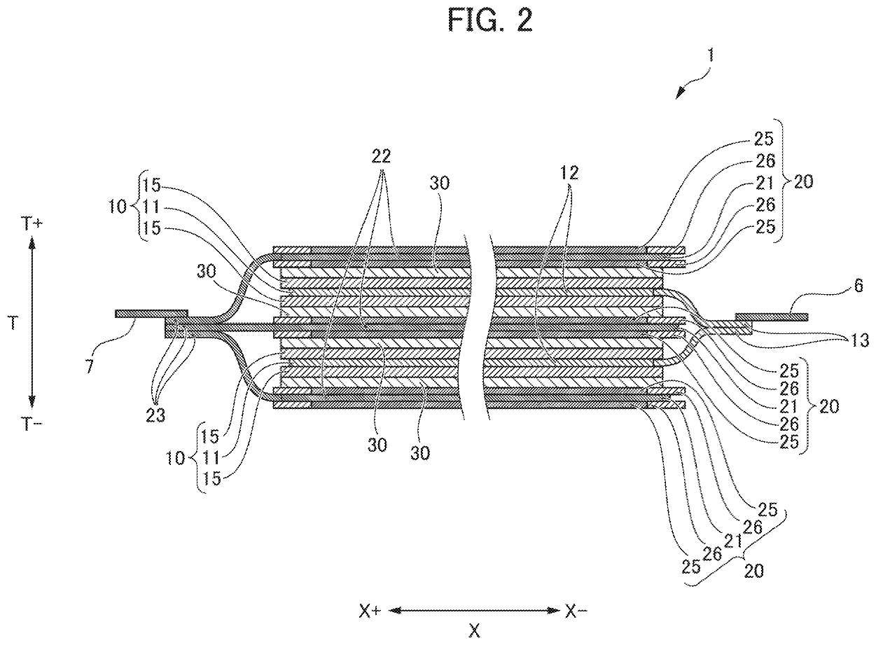

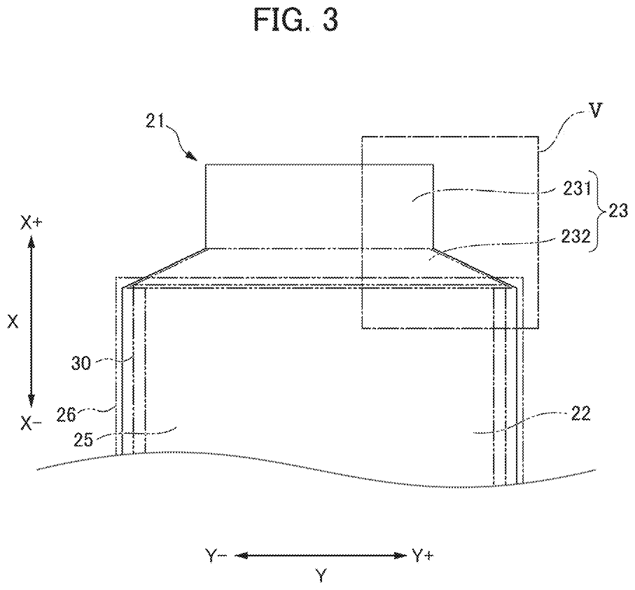

The all-solid-state battery 1 includes an outer casing 5, and also includes a negative-electrode tab lead 6 and a positive-electrode tab lead 7 as tab leads. The outer casing 5 is provided on the surface of the all-solid-state battery 1. The outer casing 5 covers the stacked structure of the negative electrodes 10, the solid electrolyte layers 30, and the positive electrodes 20. The outer casing 5 is formed of resin, for example. Note that the outer casing 5 is indicated by a dash-double-dot line in FIG. 1, and is omitted in FIGS. 2 and 3.

The negative-electrode tab lead 6 is connected to negative-electrode extension portions 13 (described later). Specifically, the negative-electrode tab lead 6 is connected to the negative-electrode extension portions 13 (described later) in a bundled state. The negative-electrode tab lead 6 is drawn out from the outer casing 5. The positive-electrode tab lead 7 is connected to positive-electrode extension portions 23 (described later). The positive-electrode tab lead 7 is drawn out from the outer casing 5.

### (Negative Electrode)

Each negative electrode 10 includes negative-electrode active material layers 15 as electrode active material layers, and a negative-electrode current collector layer 11 as a current collector layer. For example, each negative electrode 10 includes one negative-electrode current collector layer 11 and two negative-electrode active material layers 15 provided on the opposite sides of the negative-electrode current collector layer 11 in the T−direction.

Each negative-electrode active material layer 15 contains a negative-electrode active material. Examples of the negative-electrode active material include lithium metal; lithium alloys; silicon (Si); silicon-based active materials such as silicon alloys; lithium transition metal oxide such as lithium titanate (Li₄Ti₅O₁₂); transition metal oxide such as TiO₂, Nb₂O₃, and WO₃; metal sulfide; metal nitride; carbon materials such as graphite, soft carbon, and hard carbon; and metallic indium. The negative-electrode active material layer 15 preferably contains lithium metal. The negative-electrode active material layer 15 may further contain a solid electrolyte, a conductive additive, and a binder, for example.

The shape of the negative-electrode active material layer 15 is a flat-plate shape, with its plate surface extending along the X−direction and the Y−direction, for example. The shape of the negative-electrode active material layer 15, as viewed in the T−direction, is rectangular, with its long side extending along the X−direction, for example.

The negative-electrode current collector layer 11 is provided adjacent to the negative-electrode active material layers 15. The material of the negative-electrode current collector layer 11 is not limited to a particular material, but is copper, for example. The shape of the negative-electrode current collector layer 11 is a foil-like shape, for example. The negative-electrode current collector layer 11 includes a negative-electrode electrode portion 12 (which corresponds to an electrode portion) adapted to have the negative-electrode active material layers arranged thereon, and a negative-electrode extension portion 13 (which corresponds to an extension portion) extending from one end of the negative-electrode electrode portion 12.

The negative-electrode electrode portion 12 is a part of the negative-electrode current collector layer 11 that overlaps the adjacent negative-electrode active material layers 15 in the T−direction. The shape of the negative-electrode electrode portion 12, as viewed in the T−direction, is approximately rectangular, with its long side extending along the X−direction, for example.

The negative-electrode extension portion 13 is a part of the negative-electrode current collector layer 11 that extends from the negative-electrode electrode portion 12 toward one side of the X−direction (specifically, in the X−direction).

### (Solid Electrolyte Layer)

The solid electrolyte layer 30 is provided between the negative electrode 10 and the positive electrode 20. The solid electrolyte layer 30 contains a solid electrolyte material. Examples of the solid electrolyte material include a sulfide solid electrolyte material and an oxide solid electrolyte material.

### (Positive Electrode)

Each positive electrode 20 includes positive-electrode active material layers 25 and a positive-electrode current collector layer 21. For example, each positive electrode 20 includes one positive-electrode current collector layer 21 and two positive-electrode active material layers 25 provided on the opposite sides of the positive-electrode current collector layer 21 in the T−direction.

Note that the structure of the positive electrode 20 is approximately symmetrical in the Y−direction, for example. In principle, a part of the positive electrode 20 on the side of the Y+ direction will be described, and a part of the positive electrode 20 on the side of the Y− direction will be omitted. Note that the structure of the positive electrode 20 need not necessarily be approximately symmetrical in the Y−direction.

Each positive-electrode active material layer 25 contains a positive-electrode active material. Examples of the positive-electrode active material include transition metal chalcogenide such as titanium disulfide, molybdenum disulfide, and niobium selenide; and transition metal oxide such as lithium nickelate (LiNiO₂), lithium manganate (LiMnO₂ or LiMn₂O₄), and lithium cobaltate (LiCoO₂). The positive-electrode active material layer 25 may further contain a solid electrolyte, a conductive additive, and a binder, for example.

The shape of the positive-electrode active material layer 25 is a flat-plate shape, with its plate surface extending along the X−direction and the Y−direction, for example. The shape of the positive-electrode active material layer 25, as viewed in the T−direction, is rectangular, with its long side extending along the X−direction, for example.

An insulating member 26 is provided on the outer peripheral portion of each positive-electrode active material layer 25, for example.

The insulating member 26 contains a material with an electronic insulation property. Examples of the material with an electronic insulation property include insulating oxide such as alumina, resin such as polyvinylidene fluoride (PVDF), and rubber such as styrene-butadiene rubber (SBR). The insulating member 26 is preferably formed of alumina. Note that the insulating member 26 may have an ionic conduction property.

The shape of the insulating member 26 is an approximate flat-plate shape, with its plate surface extending along the X−direction and the Y−direction. The shape of the insulating member 26, as viewed in the T−direction, is an approximate rectangular-frame shape, with its long side extending along the X−direction, for example. The corners of the insulating member 26, as viewed in the T−direction, are preferably rounded. Accordingly, stress concentration at the corners of the insulating member 26 can be reduced.

The insulating member 26 can reduce short circuits in the all-solid-state battery 1, and increase the strength of the all-solid-state battery 1.

The positive-electrode current collector layer 21 is provided adjacent to the positive-electrode active material layers 25. The positive-electrode current collector layer 21 is formed of a current collector. Examples of the current collector include aluminum, copper, nickel, vanadium, iron, titanium, stainless steel, gold, platinum, and carbon. For example, the positive-electrode current collector layer 21 is formed of aluminum. The shape of the positive-electrode current collector layer 21 is a foil-like shape, for example. The positive-electrode current collector layer 21 has dimensions including a length (i.e., an X−direction dimension) of 170 mm to 1500 mm, a width (i.e., a Y−direction dimension) of 30 mm to 210 mm, and a thickness (i.e., a Z−direction dimension) of 40 mm to 360 mm, for example. The positive-electrode current collector layer 21 includes a positive-electrode electrode portion 22 (which corresponds to an electrode portion) adapted to have the positive-electrode active material layers 25 arranged thereon, and a positive-electrode extension portion 23 (which corresponds to an extension portion) extending from one end of the positive-electrode electrode portion 22.

The positive-electrode electrode portion 22 is a part of the positive-electrode current collector layer 21 that overlaps the positive-electrode active material layers 25, which are adjacent to the positive-electrode current collector layer 21, in the T−direction. Specifically, it is a part of the positive-electrode current collector layer 21 that overlaps at least one of the two positive-electrode active material layers 25, which are adjacent to the positive-electrode current collector layer 21, in the T−direction. The shape of the positive-electrode electrode portion 22, as viewed in the T−direction, is rectangular, with its long side extending along the X−direction, for example.

The positive-electrode extension portion 23 is a part of the positive-electrode current collector layer 21 that extends from the positive-electrode electrode portion 22 toward one side of the X−direction (specifically, in the X+ direction). The tip portions of the plurality of positive-electrode extension portions 23 are bundled together. The length (i.e., the X−direction dimension) of each positive-electrode extension portion 23 is set in the range of 10 mm to 90 mm, for example.

### (Configuration of Positive-Electrode Extension Portion and its Surroundings)

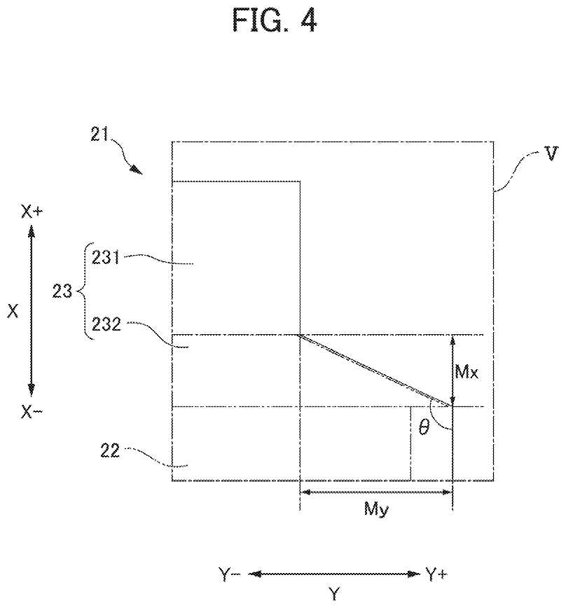

Herein, as illustrated in FIGS. 3 and 4, the positive-electrode extension portion 23 includes a positive-electrode tab region 231 (which corresponds to a tab region) having a width (i.e., a Y−direction dimension) narrower than that of the positive-electrode electrode portion 22, and a positive-electrode inclined region 232 (which corresponds to an inclined region) that is a region between the positive-electrode electrode portion 22 and the positive-electrode tab region 231, and is inclined so that a width thereof (i.e., the Y−direction dimension) narrows as it approaches the positive-electrode tab region 231 from the positive-electrode electrode portion 22 side. In FIG. 4, the positive-electrode current collector layer 21, the insulating member 26, and the solid electrolyte layer 30 are indicated by dash-double-dot lines.

The Y−direction dimension of the positive-electrode tab region 231 is constant across the entire region of the positive-electrode tab region 231 in the X−direction. Each edge in the Y−direction of the positive-electrode tab region 231 forms a straight line extending in the X−direction. The shape of the positive-electrode tab region 231, as viewed in the T−direction is, rectangular, for example.

The inclination angle θ of the positive-electrode inclined region 232 with respect to the positive-electrode electrode portion 22 is preferably 120° to 130°. Note that the inclination angle of the positive-electrode inclined region 232 with respect to the positive-electrode electrode portion 22 may simply be referred to as the “inclination angle θ”.

The positive-electrode inclined region 232, as viewed in the T−direction, is tapered from the X−direction toward the X+ direction, for example. The positive-electrode inclined region 232 overlaps the insulating member 26, as viewed in the T−direction, for example. An edge in the X+ direction of the insulating member 26 overlaps the positive-electrode inclined region 232, as viewed in the T−direction, for example.

The positive-electrode inclined region 232 is preferably inclined in a straight line.

Each positive-electrode active material layer 25 is arranged at a distance from an end portion of the positive-electrode electrode portion 22. The width (i.e., the Y− direction dimension) of an end portion of the positive-electrode inclined region 232 on the side of the positive-electrode electrode portion 22 is preferably greater than the width (i.e., the Y−direction dimension) of the positive-electrode active material layer 25. In other words, an end portion in the width direction (e.g., an end portion on the side of the Y+ direction) of the positive-electrode inclined region 232 on the side of the positive-electrode electrode portion 22 is preferably located on the outer side (e.g., on the side of the Y+ direction) of an end portion in the width direction (e.g., an end portion on the side of the Y+ direction) of the positive-electrode active material layer 25.

The insulating member 26 is preferably arranged at a distance from an end portion of the positive-electrode electrode portion 22. The insulating member 26 is preferably arranged between the end portion of the positive-electrode electrode portion 22 and the positive-electrode active material layer 25. The width (i.e., the Y−direction dimension) of the end portion of the positive-electrode inclined region 232 on the side of the positive-electrode electrode portion 22 is preferably narrower than the width (i.e., the Y−direction dimension) of the insulating member 26. In other words, the end portion in the width direction (e.g., the end portion on the side of the Y+ direction) of the positive-electrode inclined region 232 on the side of the positive-electrode electrode portion 22 is preferably located on the inner side (e.g., on the side of the Y− direction) of an end portion in the width direction (e.g., an end portion on the side of the Y+ direction) of the insulating member 26.

The ratio of the length (i.e., the X−direction dimension) of the positive-electrode inclined region 232 in the extension direction of the positive-electrode extension portion 23 to the length (i.e., the Y−direction dimension) of the positive-electrode inclined region 232 in the width direction, which is perpendicular to the extension direction, is preferably 0.25 to 0.45. Note that the length of the positive-electrode inclined region 232 in the extension direction of the positive-electrode extension portion 23 may be referred to as “Mx”, and the length of the positive-electrode inclined region 232 in the width direction perpendicular to the extension direction may be referred to as “My”. The ratio of the length of the positive-electrode inclined region 232 in the extension direction of the positive-electrode extension portion 23 to the length of the positive-electrode inclined region 232 in the width direction perpendicular to the extension direction to may be referred to as “Mx/My”.

In addition, the width (i.e., the Y−direction dimension) of the solid electrolyte layer 30 is preferably greater than the width (i.e., the Y−direction dimension) of the positive-electrode active material layer 25. In other words, an end portion in the width direction (e.g., an end portion on the side of the Y+ direction) of the solid electrolyte layer 30 is preferably located on the outer side (e.g., on the side of the Y+ direction) of an end portion in the width direction (e.g., an end portion on the side of the Y+ direction) of the positive-electrode active material layer 25.

The width (i.e., the Y−direction dimension) of the end portion of the positive-electrode inclined region 232 on the side of the positive-electrode electrode portion 22 is preferably greater than the width (i.e., the Y−direction dimension) of the solid electrolyte layer 30. In other words, the end portion in the width direction (e.g., the end portion on the side of the Y+ direction) of the positive-electrode inclined region 232 on the side of the positive-electrode electrode portion 22 is preferably located on the outer side (e.g., on the side of the Y+ direction) of an end portion in the width direction (e.g., an end portion on the side of the Y+ direction) of the solid electrolyte layer 30.

The negative-electrode extension portion 13 may have a configuration similar to that of the positive-electrode extension portion 23 described above. The negative electrode 10 may have a configuration similar to that of the positive electrode 20 described above. In the all-solid-state battery 1, one or both of the positive electrode and the negative electrode have a configuration similar to that of the positive electrode 20 described above.

(Method for Producing all-Solid-State Battery)

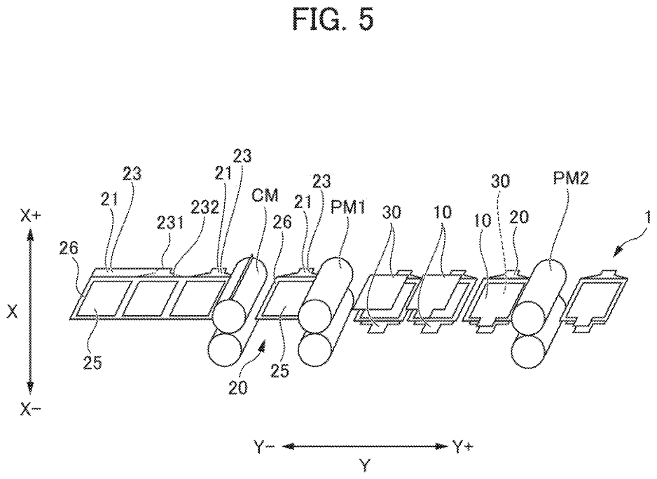

Next, a method for producing the all-solid-state battery 1 according to this embodiment will be described with reference to FIG. 5.

As illustrated in FIG. 5, first, the positive-electrode current collector layer 21 and the positive-electrode active material layers 25 are stacked to form the positive electrode 20 (i.e., a positive electrode forming step). In the positive electrode forming step, the long positive-electrode current collector layer 21, which has been rolled up on a roll, is fed by a conveying roller. Then, the positive-electrode current collector layer 21 being conveyed is coated with a positive-electrode active material to form the positive-electrode active material layers 25. The direction in which the positive-electrode current collector layer 21 is conveyed is a direction (i.e., the Y−direction) perpendicular to the extension direction (i.e., the X−direction) of the positive-electrode extension portion 23, specifically, from the Y−direction to the Y+direction. The positive-electrode active material layers 25 are formed at intervals along the design dimensions of the all-solid-state battery 1 to be completed. Accordingly, a positive-electrode connected body is obtained that includes the long positive-electrode current collector layer 21 and the plurality of positive-electrode active material layers 25 formed at intervals thereon. At this point, the insulating member 26 is formed on the positive-electrode current collector layer 21 of the positive electrode 20 along the design dimensions of the all-solid-state battery 1 to be completed. Accordingly, a positive-electrode connected body with the insulating member is obtained. Note that a gap is preferably provided between the insulating member 26 and the positive-electrode current collector layer 21.

Next, the connected body of the positive electrode 20 with the insulating member 26 is cut with a rotary cutter CM, for example (i.e., a positive electrode cutting step). Note that the method for cutting the connected body of the positive electrode 20 with the insulating member 26 is not limited to a particular method.

Herein, a part of the positive-electrode current collector layer 21 to become the positive-electrode extension portion 23 is cut into a desired shape. At this point, the positive-electrode tab region 231 and the positive-electrode inclined region 232 are formed. The inclination angle θ of the positive-electrode inclined region 232 with respect to the positive-electrode electrode portion 22 is set to 120° to 130° (i.e., a positive-electrode extension portion forming step).

Note that the positive-electrode extension portion forming step may be performed before the positive electrode cutting step.

Accordingly, the positive electrode 20 with a desired shape is obtained (described heretofore is a positive electrode preparation step). Note that the positive electrode preparation step corresponds to an electrode preparation step.

Next, the positive electrode 20 is pressed in the T-direction (i.e., a positive electrode pressing step). For example, the positive electrode 20 is roll-pressed with a roll press apparatus PM1 while being conveyed in a direction (i.e., the Y−direction) perpendicular to the extension direction (i.e., the X−direction) of the positive-electrode extension portion 23. Through the positive electrode pressing step, the density of the positive electrode 20 is increased. Specifically, to increase the density of the positive electrode 20, the temperature and pressure during the positive electrode pressing step are respectively set to 25° C. to 200° C. and 800 MPa to 1200 MPa, for example. Note that the positive electrode pressing step corresponds to a pressing step.

Next, the solid electrolyte layer 30 in the shape of a rectangular plate is stacked on the positive electrode 20. The solid electrolyte layer 30 is arranged facing the positive-electrode active material layer 25 and the insulating member 26 (i.e., a solid electrolyte layer arrangement step).

Next, the negative-electrode active material layers 15 are arranged on the negative-electrode current collector layer 11 to form the negative electrode 10 (i.e., a negative electrode forming step; not illustrated). The negative electrode 10 is stacked on the positive electrode 20 having the solid electrolyte layer 30 stacked thereon (i.e., a negative electrode arrangement step). Accordingly, a stacked structure of the negative electrode 10, the solid electrolyte layer 30, and the positive electrode 20 is obtained. Note that the negative-electrode extension portion 13 may be cut into a desired shape.

Next, the stacked structure of the negative electrode 10, the solid electrolyte layer 30, and the positive electrode 20 is pressed with a roll press apparatus PM2 (i.e., an integration pressing step). Accordingly, the positive electrode 20, the negative electrode 10, and the solid electrolyte layer 30 are integrated. At this point, the temperature is at 25° C. to 100° C., for example, and the pressure is at 500 MPa to 900 MPa, for example. Through the integration pressing step, the positive electrode 20, the negative electrode 10, and the solid electrolyte layer 30 are integrated, and the density of the solid electrolyte layer 30 is increased. Note that the integration pressing step corresponds to a pressing step. The roll press apparatus PM1 and the roll press apparatus PM2 may be collectively referred to as a “roll press apparatus PM”.

Next, though not illustrated, the tip portions of the plurality of negative-electrode extension portions 13 are bundled, and are also connected to the negative-electrode tab lead 6. The tip portions (i.e., the positive-electrode tab regions 231) of the plurality of positive-electrode extension portions 23 are bundled, and are also connected to the positive-electrode tab lead 7. Note that the positive-electrode extension portions 23 are cut at intermediate positions in the X−direction of the positive-electrode tab regions 231, for example, before being connected to the positive-electrode tab lead 7. The same applies to the negative-electrode extension portions 13. Next, the stacked structure is covered with resin to become the outer casing 5. The tip portion of the positive-electrode tab lead 7 and the tip portion of the negative-electrode tab lead 6 are each exposed from the outer casing 5.

Note that the stacking of the solid electrolyte layer 30 on the positive electrode 20 and the stacking of the negative electrode 10 on the solid electrolyte layer 30 on the positive electrode 20 are performed on each side of the positive electrode 20. Accordingly, the all-solid-state battery 1 has a structure in which the respective layers are stacked symmetrically on both the upper and lower sides, as illustrated in FIGS. 1 to 4.

Through the foregoing steps, the all-solid-state battery 1, such as the one illustrated in FIG. 1, is obtained.

### ADVANTAGEOUS EFFECTS OF EMBODIMENT

According to the foregoing embodiment, the following advantageous effects can be obtained.

The positive electrode 20 of the foregoing embodiment is an electrode including the positive-electrode active material layers 25 and the positive-electrode current collector layer 21. The positive-electrode current collector layer 21 includes the positive-electrode electrode portion 22 adapted to have the positive-electrode active material layers 25 arranged thereon, and the positive-electrode extension portion 23 extending from one end of the positive-electrode electrode portion 22. The positive-electrode extension portion 23 includes the positive-electrode tab region 231 having a width (i.e., a Y−direction dimension) narrower than that of the positive-electrode electrode portion 22, and the positive-electrode inclined region 232 that is a region between the positive-electrode electrode portion 22 and the positive-electrode tab region 231, and is inclined so that a width thereof (i.e., the Y−direction dimension) narrows as it approaches the positive-electrode tab region 231 from the positive-electrode electrode portion 22 side. The inclination angle θ of the positive-electrode inclined region 232 with respect to the positive-electrode electrode portion 22 is 120° to 130°.

Pressing the positive electrode 20 in the T−direction can increase the density of the positive electrode 20.

Meanwhile, during pressing, stress is likely to occur in a region around the proximal end portion of the positive-electrode extension portion 23 due to the difference in ductility between the positive-electrode current collector layer 21 and the positive-electrode active material layers 25. Stress concentration is likely to occur in a region around the proximal end portion of the positive-electrode tab region 231 as an edge of the positive-electrode tab region 231 is angular. However, by providing the positive-electrode inclined region 232, it is possible to allow the proximal end portion of the positive-electrode tab region 231 to be positioned away from the proximal end portion of the positive-electrode extension portion 23 in the X−direction. In addition, by increasing the inclination angle θ, it is possible to allow the proximal end portion of the positive-electrode tab region 231 to be more easily positioned away from the proximal end portion of the positive-electrode extension portion 23 in the X−direction. This can more easily reduce stress generated at the proximal end portion of the positive-electrode tab region 231.

During pressing, stress is likely to occur in a region around an end portion in the Y+ direction of the proximal end portion of the positive-electrode extension portion 23. However, by providing the positive-electrode inclined region 232, it is possible to reduce the volume of the current collector arranged in the region around the end portion in the Y+ direction of the proximal end portion of the positive-electrode extension portion 23. By reducing the inclination angle θ, it is possible to more easily reduce the volume of the current collector arranged in the region around the end portion in the Y+ direction of the proximal end portion of the positive-electrode extension portion 23. This can more easily reduce stress generated at the proximal end portion of the positive-electrode extension portion 23.

By setting the inclination angle θ to 120° to 130°, it is possible to reduce stress concentration at the proximal end portion of the positive-electrode tab region 231 and stress concentration in the region around the end portion in the Y− direction of the proximal end portion of the positive-electrode extension portion 23 in a well-balanced manner.

Thus, the all-solid-state battery 1 can be provided that can have the positive electrode 20 with high density and have a low risk of damage to the positive electrode 20.

In the positive electrode 20 of the foregoing embodiment, the positive-electrode inclined region 232 is preferably inclined in a straight line.

Such a configuration can reduce the likelihood of the formation of recesses at an edge of the positive-electrode inclined region 232, thereby reducing stress concentration in the positive-electrode inclined region 232.

In the positive electrode 20 of the foregoing embodiment, it is preferable that each positive-electrode active material layer 25 be arranged at a distance from an end portion of the positive-electrode electrode portion 22, and the width (i.e., the Y−direction dimension) of the end portion of the positive-electrode inclined region 232 on the side of the positive-electrode electrode portion 22 be greater than the width (i.e., the Y−direction dimension) of the positive-electrode active material layer 25.

Stress is likely to occur in a part of the positive-electrode extension portion 23 aligned with the positive-electrode active material layer 25 in the X−direction due to the elongation of the positive-electrode active material layer 25. Such stress is also transmitted to a portion around the part of the positive-electrode extension portion 23 aligned with the positive-electrode active material layer 25 in the X− direction. According to such a configuration, not only an edge of the part of the positive-electrode extension portion 23 aligned with the positive-electrode active material layer 25 in the X−direction, but also an edge of the portion around the part of the positive-electrode extension portion 23 aligned with the positive-electrode active material layer 25 in the X−direction can be formed in an inclined manner. Accordingly, stress concentration can be more suitably reduced.

In the positive electrode 20 of the foregoing embodiment, it is preferable that each positive-electrode active material layer 25 be arranged at a distance from an end portion of the positive-electrode electrode portion 22, the insulating member 26 be arranged between the end portion of the positive-electrode electrode portion 22 and the positive-electrode active material layer 25, and the width (i.e., the Y−direction dimension) of the end portion of the positive-electrode inclined region 232 on the side of the positive-electrode electrode portion 22 be greater than the width (i.e., the Y−direction dimension) of the insulating member 26.

The solid electrolyte layer 30 is formed of a relatively hard material. Therefore, by stacking the solid electrolyte layer 30 on the positive electrode 20 and pressing them together, it is possible to allow higher pressure to be applied to the positive electrode 20, and thus suitably increase the density of the positive electrode 20.

Note that it is considered that strain is likely to occur at the boundary between a part of the positive-electrode current collector layer 21 that overlaps the solid electrolyte layer 30 and a part of the positive-electrode current collector layer 21 that does not overlap the solid electrolyte layer 30. Therefore, stress is likely to occur in a region where a position in the Y−direction of the positive-electrode extension portion 23 is aligned with a part of the positive-electrode current collector layer 21 that overlaps an end portion in the Y+ direction of the positive-electrode active material layer 25. However, by positioning an end portion in the Y+ direction of the positive-electrode inclined region to be closer to the side of the Y+ direction than is an end portion in the Y+ direction of the solid electrolyte layer 30, it is possible to allow an edge of the part, in which stress is likely to occur, of the positive-electrode extension portion 23 to be formed in an inclined manner. Accordingly, stress concentration can be reduced.

In addition, by positioning an end portion in the Y+ direction of the insulating member 26 to be closer to the side of the Y+ direction than is an end portion in the Y+ direction of the positive-electrode inclined region 232, it is possible to reduce the contact between the positive-electrode current collector layer 21 and the negative electrode 10 in the configuration where the positive-electrode current collector layer 21 (i.e., the positive-electrode inclined region 232) extends relatively far in the Y+ direction.

In the positive electrode 20 of the foregoing embodiment, the ratio (Mx/My) of the length (Mx) of the positive-electrode inclined region 232 in the extension direction of the positive-electrode extension portion 23 to the length (My) of the positive-electrode inclined region 232 in the width direction perpendicular to the extension direction is preferably 0.25 to 0.45.

By increasing Mx/My, it is possible to allow the proximal end portion of the positive-electrode tab region 231 to be more easily positioned away from the proximal end portion of the positive-electrode extension portion 23. By decreasing Mx/My, it is possible to more easily reduce the volume of the current collector arranged in the region around the end portion in the Y−direction of the proximal end portion of the positive-electrode extension portion 23. Such a configuration can reduce stress concentration at the proximal end portion of the positive-electrode tab region 231 and stress concentration in the region around the end portion in the Y−direction of the proximal end portion of the positive-electrode extension portion 23 in a well-balanced manner.

The all-solid-state battery 1 of the foregoing embodiment is an all-solid-state battery including the positive electrode 20, the negative electrode 10, and the solid electrolyte layer 30 arranged between the positive electrode 20 and the negative electrode 10. The positive electrode of the all-solid-state battery 1 corresponds to the positive electrode 20 of the foregoing embodiment.

According to such a configuration, the all-solid-state battery 1 can be provided that can have a positive electrode with high density and have a low risk of damage to the positive electrode.

In the all-solid-state battery 1 of the foregoing embodiment, the width (i.e., the Y−direction dimension) of the solid electrolyte layer 30 is preferably greater than the width (i.e., the Y−direction dimension) of the positive-electrode active material layer 25.

As described above, if the positive-electrode active material layer 25 has a part overlapping the solid electrolyte layer 30 and a part not overlapping the solid electrolyte layer 30, pressure applied to the part of the positive-electrode active material layer 25 that overlaps the solid electrolyte layer 30 during pressing becomes higher than pressure applied to the part of the positive-electrode active material layer 25 that does not overlap the solid electrolyte layer 30. Therefore, during pressing, it is considered that a difference in elongation occurs between the part of the positive-electrode active material layer 25 that overlaps the solid electrolyte layer 30 and the part of the positive-electrode active material layer 25 that does not overlap the solid electrolyte layer 30. Thus, it is considered that strain is likely to occur at the boundary between a part of the positive-electrode current collector layer 21 that overlaps the positive-electrode active material layer 25 and also overlaps the solid electrolyte layer 30, and a part of the positive-electrode current collector layer 21 that overlaps the positive-electrode active material layer 25 but does not overlap the solid electrolyte layer 30.

However, according to the foregoing configuration, it is possible to more easily achieve uniform elongation of the positive-electrode active material layer 25 during pressing, thereby reducing the occurrence of strain in the positive-electrode active material layer 25. Accordingly, stress generated in the positive-electrode active material layer 25 can be reduced.

In the all-solid-state battery 1 of the foregoing embodiment, the width (i.e., the Y−direction dimension) of the end portion of the positive-electrode inclined region 232 on the side of the positive-electrode electrode portion 22 is preferably greater than the width (i.e., the Y−direction dimension) of the solid electrolyte layer 30.

According to such a configuration, by positioning an end portion in the Y+ direction of the positive-electrode inclined region to be closer to the side of the Y+ direction than is an end portion in the Y+ direction of the solid electrolyte layer 30, it is possible to allow an edge of the part, in which stress is likely to occur, of the positive-electrode extension portion 23 to be more reliably formed in an inclined manner. Accordingly, stress concentration can be reduced.

The method for producing the positive electrode 20 of the foregoing embodiment includes a positive electrode preparation step of preparing the positive electrode 20 that includes the positive-electrode active material layers 25 and the positive-electrode current collector layer 21, the positive-electrode current collector layer 21 including the positive-electrode electrode portion 22 adapted to have the positive-electrode active material layers 25 arranged thereon, and the positive-electrode extension portion 23 extending from one end of the positive-electrode electrode portion 22, the positive-electrode extension portion 23 including the positive-electrode tab region 231 having a width (i.e., a Y−direction dimension) narrower than that of the positive-electrode electrode portion 22, and the positive-electrode inclined region 232 that is a region between the positive-electrode electrode portion 22 and the positive-electrode tab region 231, and is inclined so that a width thereof (i.e., the Y−direction dimension) narrows as it approaches the positive-electrode tab region 231 from the positive-electrode electrode portion 22 side, the inclination angle θ of the positive-electrode inclined region 232 with respect to the positive-electrode electrode portion 22 being 120° to 130°; and a positive electrode pressing step of roll-pressing the positive electrode in a direction (i.e., the Y−direction) perpendicular to the extension direction of the positive-electrode extension portion 23.

According to such a production method, the density of the positive electrode 20 can be increased with a simple method.

If the positive-electrode current collector layer 21 is pressed with a roll press apparatus PM while being conveyed in the Y−direction relative to the roll press apparatus PM, a difference between the elongation in the Y−direction of the positive-electrode electrode portion 22 and the elongation in the Y−direction of the positive-electrode extension portion 23 is particularly likely to occur, which in turn increases the likelihood of fracture of the positive-electrode current collector layer 21. However, the likelihood of fracture of the positive-electrode current collector layer 21 can be reduced according to the positive electrode 20 of the present invention. Thus, the foregoing production method can be suitably applied.

Thus, a positive electrode production method can be provided that can produce the positive electrode 20 with high density, and can reduce the risk of damage to the positive electrode 20.

The present invention is not limited to the configuration of the foregoing embodiment, and may be modified as appropriate to be applied without departing from the scope of the present invention. Note that a combination of two or more of the individual preferred configurations described in the foregoing embodiment also falls within the scope of the present invention.

For example, although the foregoing embodiment has illustrated the positive electrode 20 as an electrode, the negative electrode 10 as an electrode may have a configuration corresponding to the configuration of the positive electrode 20 of the foregoing embodiment.

Although the foregoing embodiment has illustrated a lithium-ion battery as an example of a solid-state battery, the present invention is not limited to solid-state batteries, and is also applicable to a secondary battery including a liquid electrolyte and a separator. Further, the present invention is also applicable to batteries other than lithium-ion batteries.

### EXAMPLES

CAE analysis and press tests were conducted. The CAE analysis is a simulation performed with data. The press tests are tests performed with the actual positive electrodes.

### [CAE Analysis]

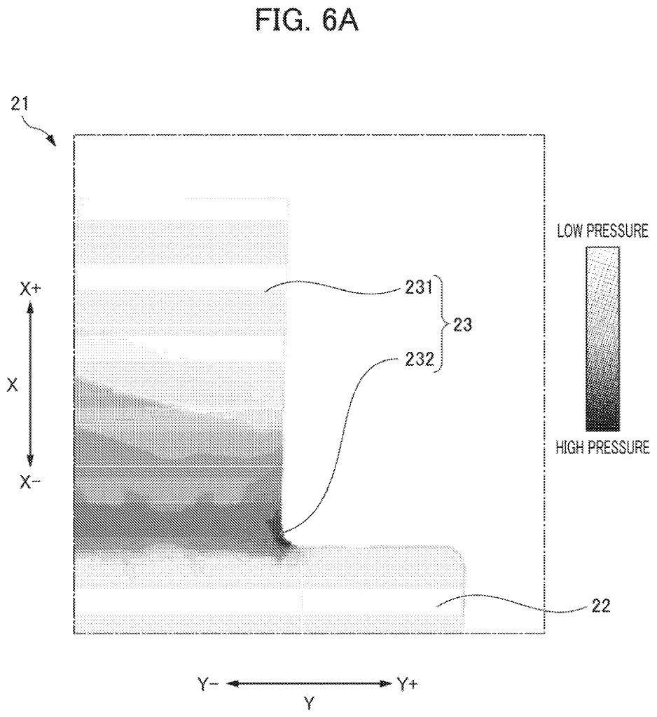

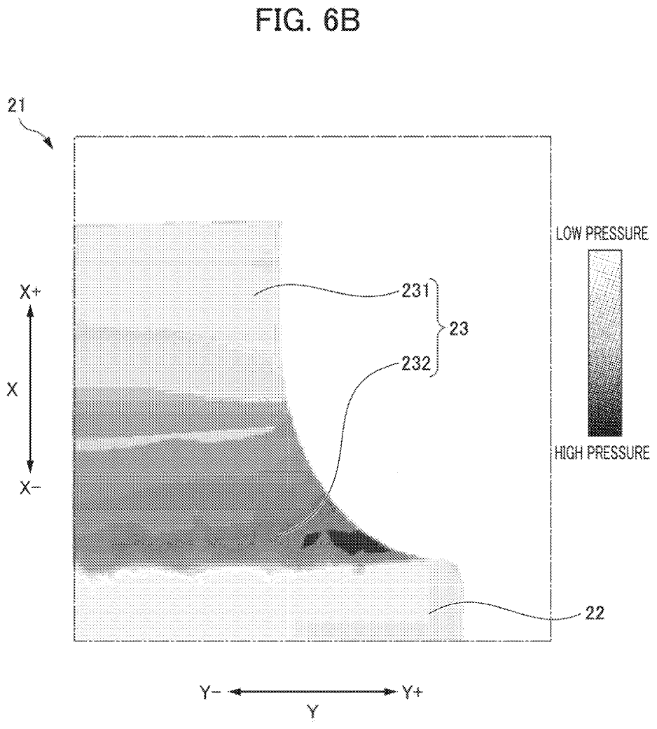

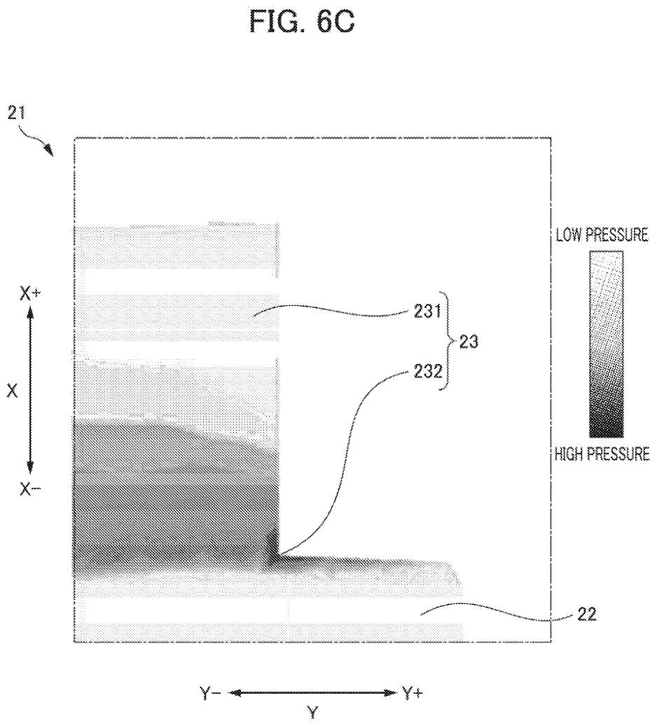

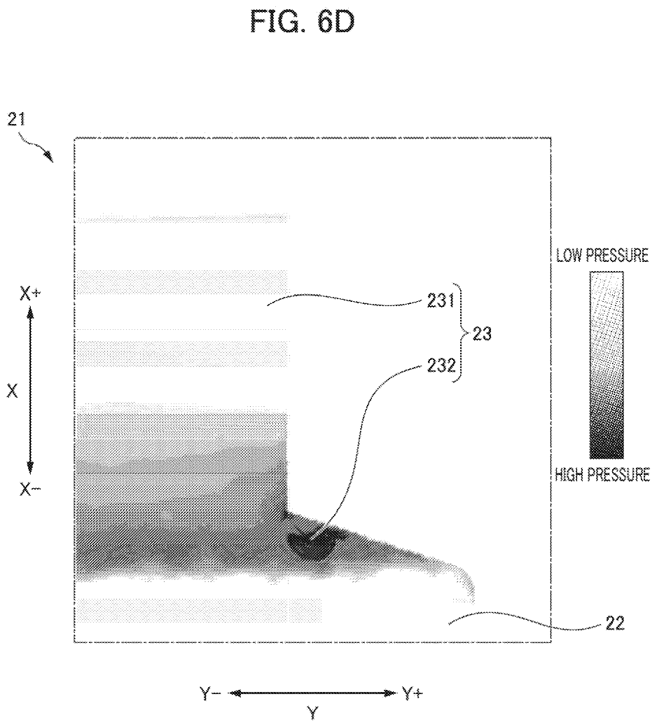

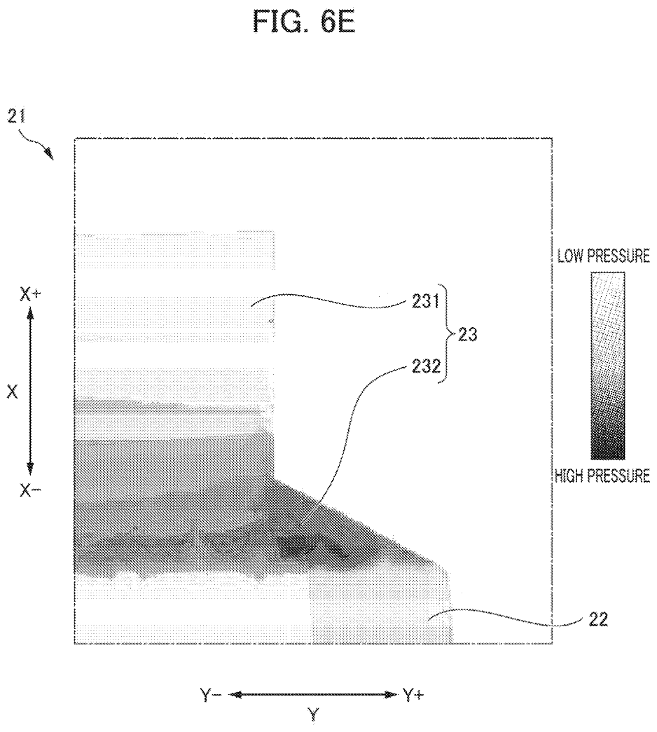

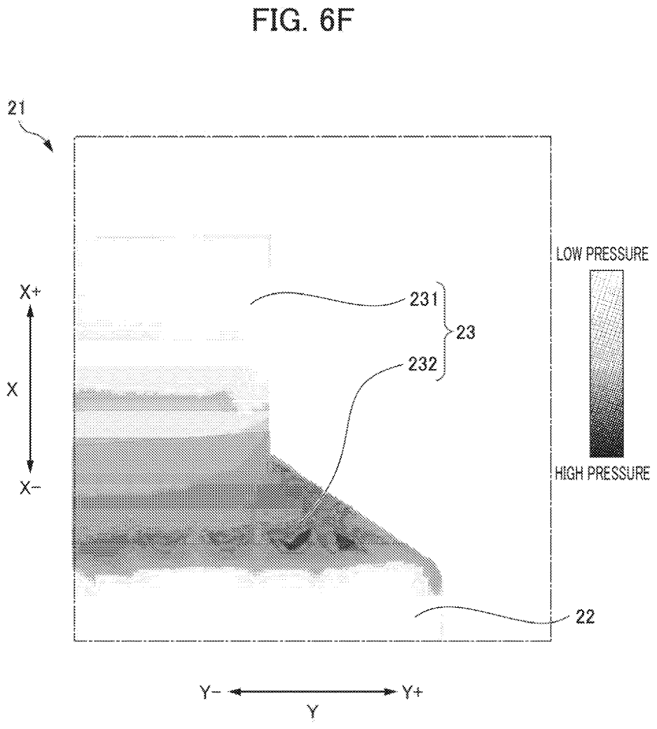

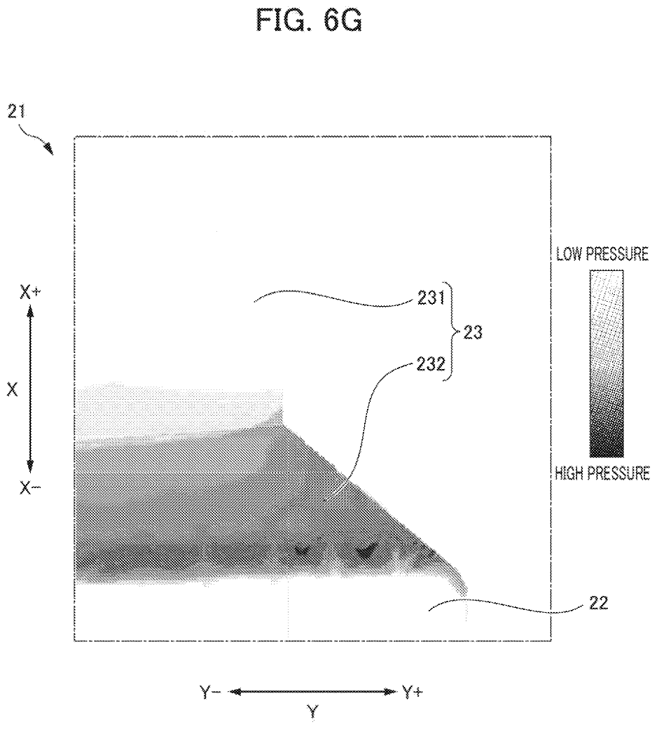

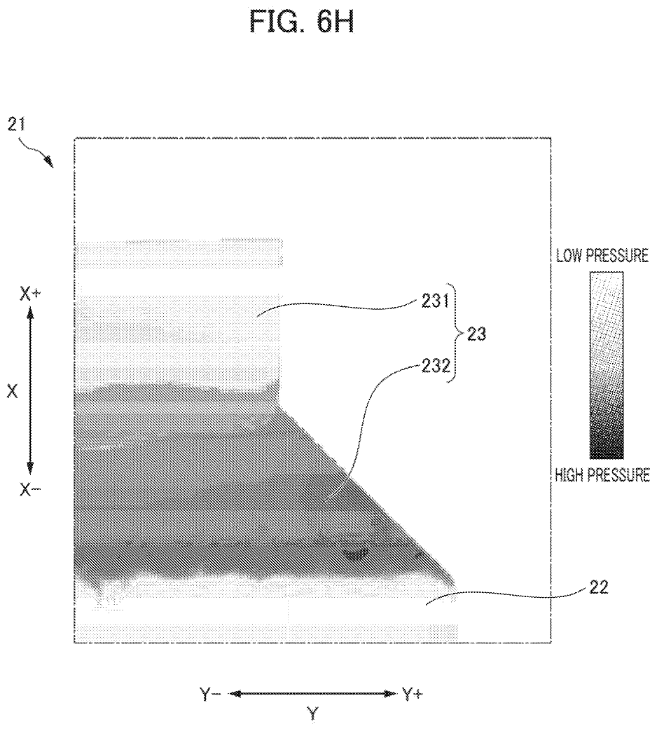

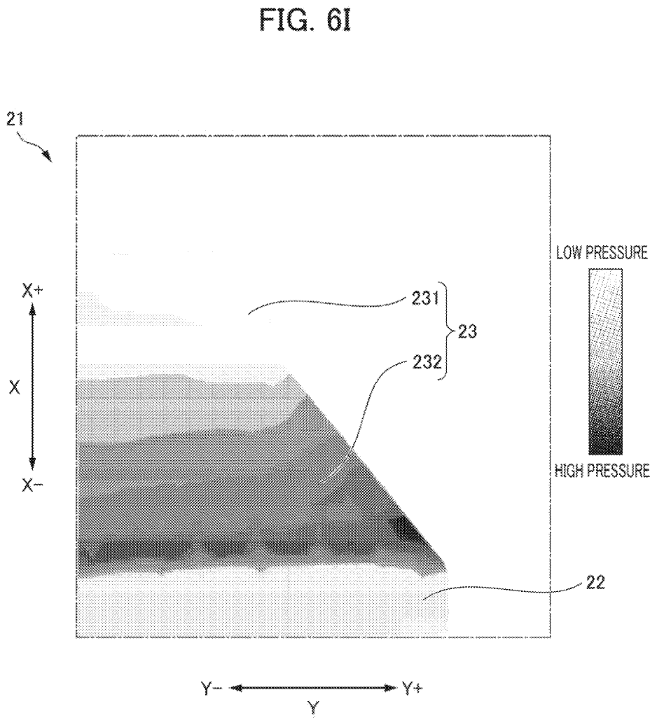

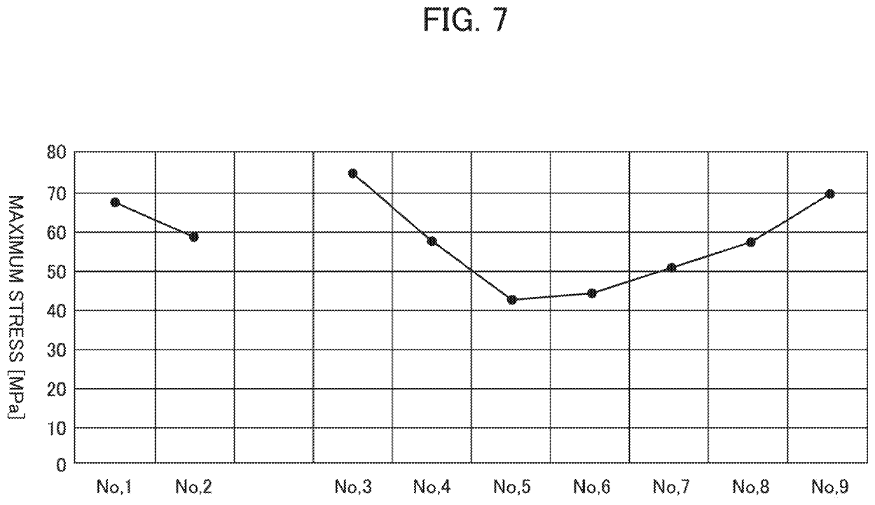

First, as illustrated in FIG. 6G, for example, a region of a positive electrode layer as viewed in the T−direction, which is a partial region on the side of the X+ direction and the side the Y+ direction, and includes the entire edge in the Y+ direction of a positive-electrode extension portion, was selected as a target analysis region. Positive-electrode current collector layers (Nos. 1 to 9) were prepared as the CAE analysis models. The thickness of each positive-electrode current collector layer was set to 0.1 mm. The dimension in the extension direction (i.e., the X−direction dimension) of the positive-electrode extension portion was set to 30 mm. The shape of the inclination of the inclined region, Mx/My, and the inclination angle θ were set as illustrated in Table 1 below. Mx/My was adjusted by changing Mx while keeping My constant. Aluminum was used as the material of each positive-electrode current collector layer. Conducted was a simulation of a case where each of the foregoing positive-electrode current collector layers was pressed in the T−direction perpendicular to the longitudinal direction of the extension portion. A stress distribution in the positive-electrode current collector layer within the target analysis region during pressing was determined. FIGS. 6A to 6I illustrate the results. In FIGS. 6A to 6I, portions with higher stress in the target analysis region are indicated in darker colors. FIG. 7 is a graph illustrating the maximum stress applied during the press test for each of the positive-electrode current collector layers (Nos. 1 to 9).

TABLE 1

| No. of | | | | | |
|---|---|---|---|---|---|
| Positive- | Shape of Extension Portion | | | | |
| Electrode | Shape of | | | Results of Analysis | |
| Current | Inclination | | | Maximum | |
| Collector | of Inclined | | Inclination | Stress | Deter- |
| Layer x | Region | Mx/My | Angle θ | (MPa) | mination |
| 1 | Curved Line | 0.07 | — | 67 | Poor |
| | (r = 2 mm) | | | | |
| 2 | Curved Line | 0.60 | — | 58 | Generally |
| | (r = 20 mm) | | | | Good |
| 3 | Straight Line | 0 | 90 | 75 | Poor |
| 4 | Straight Line | 0.17 | 110 | 57 | Generally |
| | | | | | Good |
| 5 | Straight Line | 0.26 | 120 | 43 | Good |
| 6 | Straight Line | 0.34 | 124 | 44 | Good |
| 7 | Straight Line | 0.44 | 130 | 50 | Good |
| 8 | Straight Line | 0.50 | 135 | 56 | Generally |
| | | | | | Good |
| 9 | Straight Line | 0.67 | 142 | 70 | Poor |

As illustrated in FIG. 7, if extreme stress concentration occurs around the proximal end portion of the positive-electrode extension portion of the positive-electrode current collector layer, there is a risk of fracture at the stress concentration point. Thus, the maximum stress in the target analysis region was evaluated. If the maximum stress in the target analysis region was less than or equal to the maximum stress (50 MPa) in the target analysis region of No. 7, the result was determined to be “Good”. If the maximum stress in the target analysis region was greater than the maximum stress (50 MPa) in the target analysis region of No. 7, the result was determined to be “Poor”.

Regarding each of the positive-electrode current collector layers of Nos. 1 and 2, it is found that stress concentration is relatively likely to occur. Note that even when an edge of the positive-electrode inclined region has the shape of an arc, it is found that the maximum stress value becomes smaller as the Mx/My value is larger.

Regarding each of the positive-electrode current collector layers of Nos. 3 and 4, which are examples where the Mx/My value is relatively small and the inclination angle θ is relatively small, it is found that stress concentration is relatively likely to occur (see FIGS. 6C and 6D). Regarding each of the positive-electrode current collector layers of Nos. 3 and 4, it is found that stress concentration is likely to occur around the base of the positive-electrode tab region. It is considered that if Mx/My is small and the inclination angle θ is small, fracture is likely to occur around the base of the positive-electrode tab region.

Regarding each of the positive-electrode current collector layers of Nos. 5 to 7, it is found that stress concentration is relatively unlikely to occur.

Regarding each of the positive-electrode current collector layers of Nos. 8 and 9, which are examples where the Mx/My value is relatively large and the inclination angle θ is relatively large, it is found that stress concentration is more likely to occur than in the positive-electrode current collector layer of No. 7. Regarding each of the positive-electrode current collector layers of Nos. 8 and 9, it is found that stress concentration is likely to occur around an edge in the Y−direction of the base of the positive-electrode extension portion (see FIGS. 6H and 6I). It is considered that if Mx/My is large and the inclination angle θ is large, fracture is likely to occur around an edge in the Y−direction of the base of the positive-electrode extension portion.

Note that the threshold (50 MPa) for determining the presence or absence of stress concentration is set based on the maximum stress in the target analysis region of No. 7. As will be described in detail later, regarding an example corresponding to No. 7 (Example 1), no fracture occurred in the target analysis region during the press test. Therefore, if the maximum stress in the target analysis region is lower than that of No. 7, it is considered that the likelihood of fracture of the positive-electrode current collector layer can be sufficiently reduced.

### [Press Test]

### Example 1

### (Positive Electrode)

Rectangular aluminum foil with a length of 516 mm, a width of 94 mm, and a thickness of 125 mm was prepared as a positive-electrode current collector. A positive-electrode active material layer and an insulating member were formed on one surface of the positive-electrode current collector, using a method described below. One end portion in the longitudinal direction (i.e., the X−direction) of the positive-electrode current collector was formed as a positive-electrode extension portion on which neither the positive-electrode active material layer nor the insulating member is formed. The length of the positive-electrode extension portion was set in the range of 30 mm from the end portion in the longitudinal direction of the positive-electrode current collector.

### (Method for Forming Positive-Electrode Active Material Layer)

A mixture of lithium nickel cobalt manganese composite oxide as an electrode active material, a sulfide solid electrolyte as a solid electrolyte material, acetylene black as a conductive additive, and a PVDF (polyvinylidene fluoride)-based binder as a binder was arranged at intervals on the surface of the positive-electrode current collector to form positive-electrode active material layers.

### (Method for Forming Insulating Member)

A mixture of alumina as an insulating material and a PVDF-based binder as a binder was applied to a part of the positive-electrode current collector to which the positive-electrode active material layers had not been applied, so that an insulating member was formed. The thickness of the obtained insulating member was set to be approximately the same as that of each positive-electrode active material layer.

### (Shape of Positive-Electrode Extension Portion)

Next, the positive-electrode extension portion was shaped to match the CAE analysis model No. 7. Specifically, the positive-electrode extension portion was cut into a desired shape. The positive-electrode extension portion was formed with a positive-electrode tab region and a positive-electrode inclined region. The X−direction dimension of the positive-electrode tab region was set to 30 mm, and the Y−direction dimension of the positive-electrode tab region was set to 50 mm. The distance in the Y−direction between an end portion in the Y+ direction of the positive-electrode tab region and an end portion in the Y+ direction of the insulating member was set to 22 mm. The position of an end portion in the Y+ direction of the positive-electrode inclined region was set to overlap an end portion in the X+ direction of the insulating member, as viewed in the T−direction.

The positive-electrode current collector layer of the press-test analysis model of Example 1 was formed with the same shape as that of the CAE analysis model No. 7. Therefore, the shape of the positive-electrode inclined region, Mx, My, and the inclination angle θ of the press-test analysis model of Example 1 are the same as those of the CAE analysis model No. 7.

While the press-test analysis model of Example 1 was conveyed in the short-side direction (i.e., the Y−direction) of the positive-electrode current collector layer, the positive-electrode active material layer and the insulating member were pressed at a pressure of 800 MPa using a roll press machine. Then, the press-test analysis model was taken apart, and the positive-electrode current collector layer was visually inspected. It was confirmed whether fracture had occurred in the target analysis region.

Regarding the positive electrode of Example 1, no fracture was observed in the positive-electrode current collector layer.

### Comparative Example 1

A positive electrode was produced in a similar manner to Example 1, except that the shape of the extension portion was made identical to that of the positive-electrode current collector layer No. 1 as a CAE analysis model. When the obtained positive electrode was pressed as in Example 1, fracture was observed in the inclined portion.

### Comparative Example 2

A positive electrode was produced in a similar manner to Example 1, except that the shape of the extension portion was made identical to that of the positive-electrode current collector layer No. 2 as a CAE analysis model. When the obtained positive electrode was pressed as in Example 1, fracture was observed in the inclined portion.

### EXPLANATION OF REFERENCE NUMERALS

1: all-solid-state battery, 6: negative-electrode tab lead (i.e., tab lead), 7: positive-electrode tab lead (i.e., tab lead), 10: negative electrode (i.e., electrode), 11: negative-electrode current collector layer (i.e., current collector layer), 15: negative-electrode active material layer (i.e., electrode active material layer), 20: positive electrode (i.e., electrode), 21: positive-electrode current collector layer (i.e., current collector layer), 22: positive-electrode electrode portion (i.e., electrode portion), 23: positive-electrode extension portion (i.e., extension portion), 25: positive-electrode active material layer (i.e., electrode active material layer), 26: insulating member, 30: solid electrolyte layer, 231: positive-electrode tab region (i.e., tab region), 232: positive-electrode inclined region (i.e., inclined region), PM1, PM2: roll press apparatus.

What is claimed is:

1. An electrode comprising an electrode active material layer and a current collector layer,
the current collector layer including an electrode portion adapted to have the electrode active material layer arranged on the electrode portion, and an extension portion extending from one end of the electrode portion,
the extension portion including a tab region having a width narrower than that of the electrode portion, and an inclined region that is a region between the electrode portion and the tab region, and is inclined so that a width thereof narrows as the inclined region approaches the tab region from the electrode portion side, and
an inclination angle of the inclined region with respect to the electrode portion being 120° to 130°.

2. The electrode according to claim 1, wherein the inclined region is inclined in a straight line.

3. The electrode according to claim 1, wherein the electrode active material layer is arranged at a distance from an end portion of the electrode portion, and a width of an end portion of the inclined region on a side of the electrode portion is greater than a width of the electrode active material layer.

4. The electrode according to claim 1, wherein
the electrode active material layer is arranged at a distance from an end portion of the electrode portion, and an insulating member is arranged between the end portion of the electrode portion and the electrode active material layer, and
a width of an end portion of the inclined region on a side of the electrode portion is narrower than a width of the insulating member.

5. The electrode according to claim 1, wherein a ratio of a length of the inclined region in an extension direction of the extension portion to a length of the inclined region in a width direction perpendicular to the extension direction is 0.25 to 0.45.

6. An electrode production method comprising:
an electrode preparation step of preparing an electrode that includes an electrode active material layer and a current collector layer, the current collector layer including an electrode portion adapted to have the electrode active material layers arranged on the electrode portion, and an extension portion extending from one end of the electrode portion, the extension portion including a tab region having a width narrower than that of the electrode portion, and an inclined region that is a region between the electrode portion and the tab region, and is inclined so that a width thereof narrows as the inclined region approaches the tab region from the electrode portion side, an inclination angle of the inclined region with respect to the electrode portion being 120° to 130°; and
a pressing step of roll-pressing the electrode in a direction perpendicular to an extension direction of the extension portion.

7. An all-solid-state battery comprising a positive electrode, a negative electrode, and a solid electrolyte layer arranged between the positive electrode and the negative electrode,
one or both of the positive electrode and the negative electrode being the electrode according to claim 1.

8. The all-solid-state battery according to claim 7, wherein a width of the solid electrolyte layer is greater than a width of the electrode active material layer.

9. The all-solid-state battery according to claim 7, wherein a width of an end portion of the inclined region on a side of the electrode portion is greater than a width of the solid electrolyte layer.
